(19) United States
(12) Patent Application Publication
(10) Pub. No.: US 2009/0011106 A1
(43) Pub. Date: Jan. 8, 2009

(54) Method and device for manufacture, storage, marketing and promotion of ice-creams and popsicles

(76) Inventors: Nimrod Givati, Givataim (IL); Uzi Ezra Havosha, Tel Aviv (IL)

Correspondence Address: UZI EZRA HAVOSHA & PARTNERS, HADAR-DAFNA HOUSE 39 SHAOUL HAMELECH STREET, TEL AVIV, 64928, IL

(21) Appl. No.: 11/825,261

(22) Filed: Jul. 6, 2007

(51) Int. Cl. A23G 9/04; A23G 9/28

(52) U.S. Cl. 426/565

(57) ABSTRACT

An hollow popsicle or ice-cream container or holding stick wherein the hollow is filled with coolants or edible liquids frozen with the popsicle or ice-cream. Option to drink the contents of the said hollow portions. Packing the popsicles or ice-creams in such a way that they promote the preservation of coolness amongst themselves. Attaching to the holding stick, shaped articles, numbers, words and the like for games or to collect sets or to take part in a lottery for marketing and promotion purposes.

### FIELD OF THE INVENTION

This invention is in the field of the ice-cream industry and in particular innovative methods of packaging storing and marketing ice-cream, ices and the like.

### BACKGROUND OF THE INVENTION

It is well known especially in countries with hot climates that ice-creams and ices present a problem when bought to take home or even bought to eat. The problem is that the products start to melt soon after being removed from the freezer of the retailer. Even when the ices are eaten immediately, when it is a hot day the ice often starts to drip before finishing the product. This is especially so when children are the consumer as they tend to take a longer time to finish eating than adults. The resultant drips of ice-cream often cause inconvenience and damage.

One of the main problems is when taking the product home in a hot car or on a bus journey. Once the product starts to melt it loses its form and when re-frozen its taste and texture change. In addition it is less attractive to serve at a meal after being partially melted.

This invention comes to solve these problems and adds some marketing and promotional features at the same time.

### SUMMARY OF THE INVENTION

It is to be understood that both the foregoing general description and the following detailed description present embodiments of the invention and are intended to provide an overview or framework for understanding the nature and character of the invention as it is claimed. The accompanying drawings are included to provide a further understanding of the invention and are incorporated into and constitute a part of this specification. The drawings illustrate various embodiments of the invention and, together with the description, serve to explain the principles and operations of the invention. Where ices are mentioned herein the intention is to include any kind of ices, ice popsicle, ice-cream and similar products.

An object of the invention is to increase comfort and convenience at the time of serving ices.

Another object of the invention is to keep ices frozen and cold for longer after leaving the freezer.

Another object of the invention is to protect ices from breaking or being crushed.

Another object of the invention is to have a tray to hold ices. Such a tray could be transparent, openably sealed, decoratively shaped, designed to hold captions, graphics, advertisements, promotion and publicity.

Another object of the invention is for the liquids in the hollow of the said tray to be colored.

An object of this invention is to have a storage container that has a double wall or space between the tray where the ices are situated and the outer wall. This space is for filling with water, gel or other substances whether edible or not, that will freeze with the ices in the freezer and when removed from the freezer will help keep cool, insulate and protect the ices from melting so fast. The said substances in the hollow of the container or of the holding stick could be attractive substances for sales and promotion for example caffeine drinks like “red-bull” or alcohol. The ices will be in close contact, separated by the relatively thin layer of the ices tray, with the frozen liquid or gel which will keep the ices frozen for longer than without this frozen insulation.

Another object of this invention is to store more than one ices together in a manner that a large percentage of their surface area is touching or close to its neighbor thereby keeping all the ices colder for longer. For example, if the ices are manufactured in the shape of a triangular prism, many ices can fit together where one longitudinal side face of each ice tapers to the center and the outside face forms a cylindrical shape when all the ices are in place. The more said surface area that is touching a neighboring ice the less the surface area that is exposed to the air and that helps to maintain the ices in a frozen state for longer.

Another method of keeping ices cold for longer is for the ice cream stick to be hollow and filled with a liquid that will help lower the temperature of the ice cream. The shape of the stick could be made to spread where it is in contact with the ices to increase the cooling effect. The part of the stick that is held by the consumer's hand could be solid and not hollow to prevent the consumer holding a very cold stick handle. This embodiment has the advantage of helping to keep cool for longer individual ices while the consumer is in the process of consuming.

Another object of the invention is to have a drip tray to catch drips of ices and a convenient mouthpiece in the drip tray for the consumption of the melted contents and the drips. This embodiment could be made in conjunction with the previous embodiment namely the hollow stick cooling effect.

The aforementioned spread-out stick inside the ice cream could be utilized for promotional and marketing purposes for example, there could be break-off figures attached to the stick that children would enjoy collecting in sets, or other games or forms of lottery to win prizes based on articles attached to the stick or wording written or embossed on the stick.

### BRIEF DESCRIPTION OF THE DRAWINGS

The accompanying drawings, which are incorporated in and form a part of this specification, illustrate embodiments of the invention and together with the description, serve to explain by way of example only, the principles of the invention:

FIG. 1 is a schematic depiction in isometric projection of a popsicle tray.

FIG. 2 is a schematic depiction in isometric projection of a popsicle tray with a base tray.

FIG. 3 is a sectional view of an ice-cream popsicle tray.

FIG. 4 is a schematic depiction in isometric projection of a multi-layered circular popsicle set of trays.

FIG. 5A is a schematic depiction of a method of storing ice-cream popsicles.

FIG. 5B is a schematic depiction of one such popsicle.

FIG. 5C is a schematic depiction of a cover for such a group of popsicles.

FIG. 6 is a schematic depiction of a popsicle stick with a container attached.

FIG. 7 is a schematic depiction of a popsicle stick in a shape with novelties attached thereto.

FIG. 8 is a schematic depiction of an ice-cream container with hollow sections fillable with liquids.

FIG. 9 is a schematic depiction of an insulated ice-cream cone holder.

FIG. 10 is a schematic depiction of an insulated ice-cream or popsicle sleeve.

FIG. 11 is a schematic depiction of an insulated folding popsicle case.

### DETAILED DESCRIPTION OF THE PREFERRED EMBODIMENTS

As will be appreciated the present invention is capable of other and different embodiments than those discussed above and described in more detail below, and its several details are capable of modifications in various aspects, all without departing from the spirit of the invention.

Accordingly, the drawings and description of the embodiments set forth below are to be regarded as illustrative in nature and not restrictive.

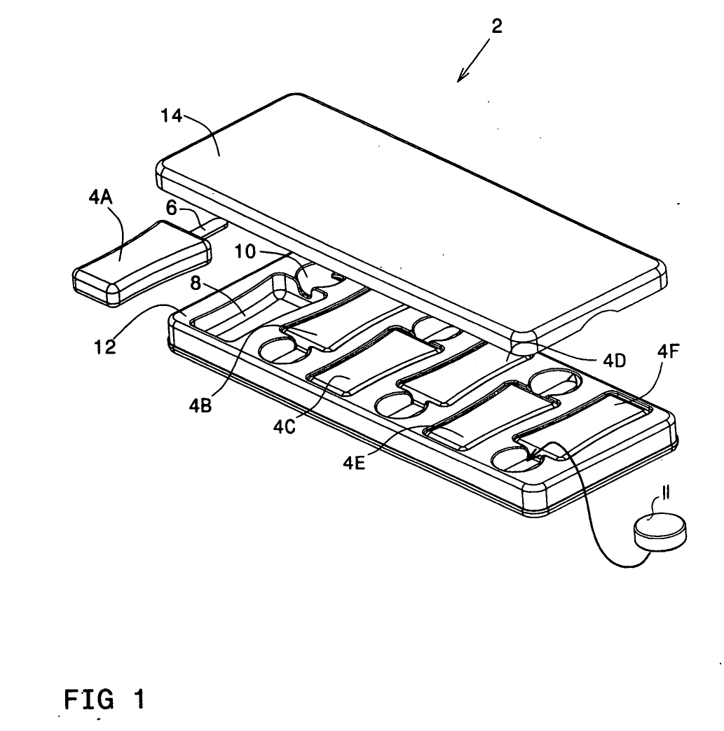

FIG. 1 shows one embodiment of an ice popsicle tray 2 of this invention. The individual ices or popsicles 4A-4F are made by adding the liquid substance of the ice to the empty form 8 with the stick 6 in place and placing the tray 2 in a freezer. The depression 10 is to ease the removal of the ice popsicle using fingers. The stopper 11 fits tightly into the depression 10 to prevent that space being filled with liquids that will freeze with the ice popsicle and hinder the removal of the ice popsicle.

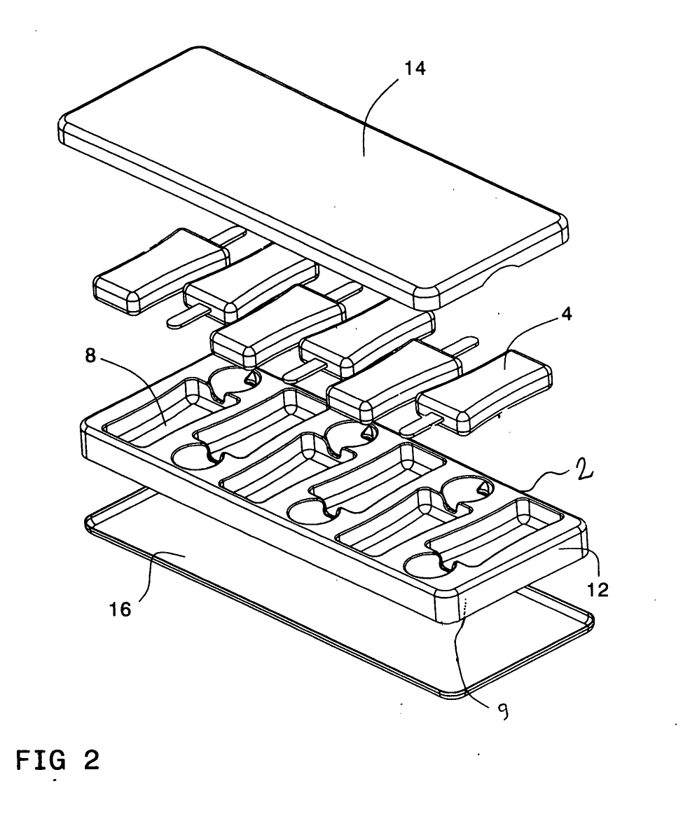

The base 12 of the tray and the lid 14 of the tray help to protect the ices from physical damage and freezer burn damage. The tray 2 has hollow parts as is described in relation to FIG. 2.

FIG. 2 shows the ice popsicle tray 2 with frozen ices 4 in an expanded state to show the component parts more clearly. The lower portion 12 of the tray 2 is made of depressions 8 to accommodate the ices and in between those depressions is space 9.

The lower portion 12 can be inverted and filled with liquid or gel to help to keep the ices cooler for longer. The space 9 could be initially filled with liquid, sealed by the lower cover 16 and frozen in a freezer. Once frozen the lower portion 12 could be turned the correct way up so that the liquid of the ices could be poured into the ices depression 8. Then the lid 14 is placed on the lower portion 12 and placed in the freezer to make the ices 4 frozen.

An alternative method of filling the space 9 could be as follows if the seal between the lower cover 16 and the lower portion 12 of the tray 2 is a water-tight seal. The lower portion 12 is inverted and filled with the filling liquid, sealed closed with the lower cover 16 and turned upright again to pour into the depressions 8 the liquid the substance of the ices 4. The lid 14 is placed on the lower portion 12 and placed in the freezer where both liquids will freeze at the approximately same time.

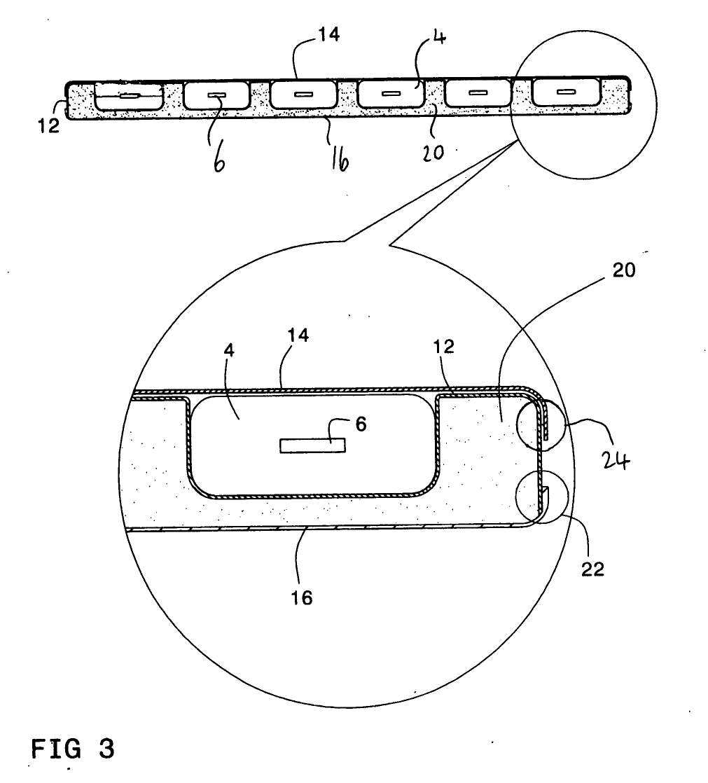

FIG. 3 shows the sectional view of an embodiment the ice popsicle tray of this invention, with one portion enlarged for clarity. The ice popsicle 4 is seen in its depression with its stick 6. In between the said depressions is filled with the liquid or cooling gel 20. The lower cover 16 and lid 14 keep the liquids in place until they are frozen. The seal 22 between the lower portion 12 of the tray and the lower cover 16 and the seal 24 between the lower portion 12 of the tray and the lid 14 are preferably water-tight.

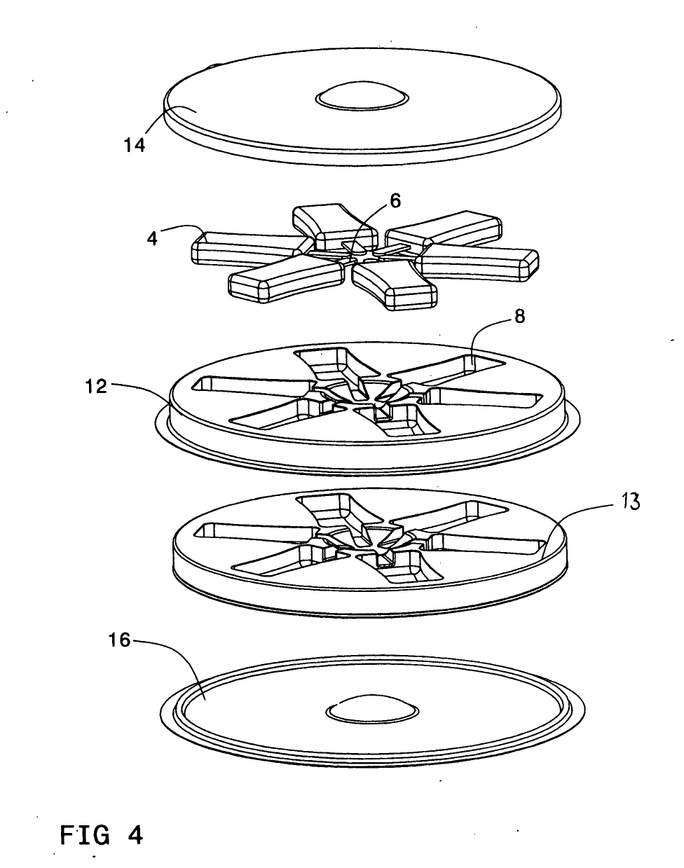

FIG. 4 shows an ice popsicle tray with the same basic features and innovation as the tray described in FIGS. 1-3 but in a round shape and two layers of ice popsicle trays instead of one layer. The ices 4 are in a position in such a way that their sticks 6 are close to the center of the circle and the ice potion 4 faces the circumference of the circle. The depressions 8 are arranged accordingly. The upper tray 12 and lower tray 13 are one on top of the other with the lid 14 and lower cover 16 sealing the top and bottom. The cooling ice is formed from liquid placed in between the lower cover 16 and the hollow portions under tray 13.

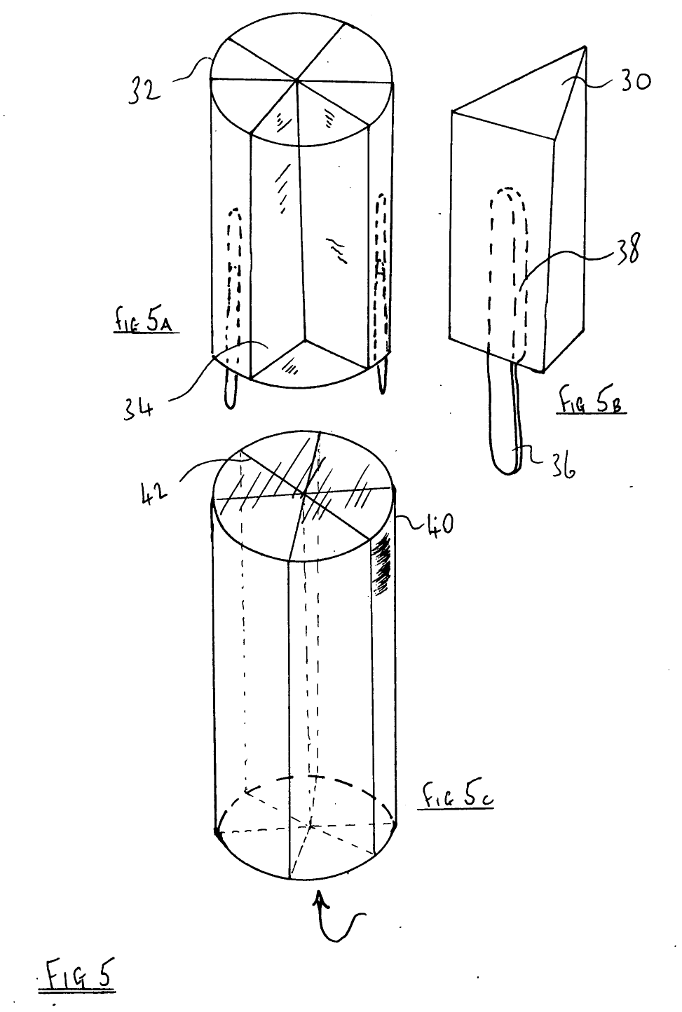

FIG. 5 shows an alternative method of storing ice popsicles in order to keep them cooler for longer once the ices have left the freezer. The ices are in triangular shape FIG. 5B 30 and when placed adjacent to other similar shaped ices will form a circular shape FIG. 5A 32. The relatively large surface area 34 of each ice popsicle touching its neighbor aids the ices to remain colder for longer after being removed from the freezer.

The ices stick 36 could have a hollow portion 38 that could be filled with a liquid, edible or inedible, or gel for the purpose of keeping the ices cooler for longer after leaving the freezer.

The cover of the ice popsicles FIG. 5C 40 could be made in sections 42 to form the desired shape of the ices. The cover 40 could be inverted to enable the liquid ice popsicle substance to be poured in. The cover 40 would then be placed inverted in a freezer until the said liquid is frozen. The walls of the cover 40 could be hollow walls to contain one of the above mentioned liquids to keep the ices or ice cream cooler for longer after leaving the freezer.

It is understood that this container could be rectangular or other shape using the same principle as this described embodiment.

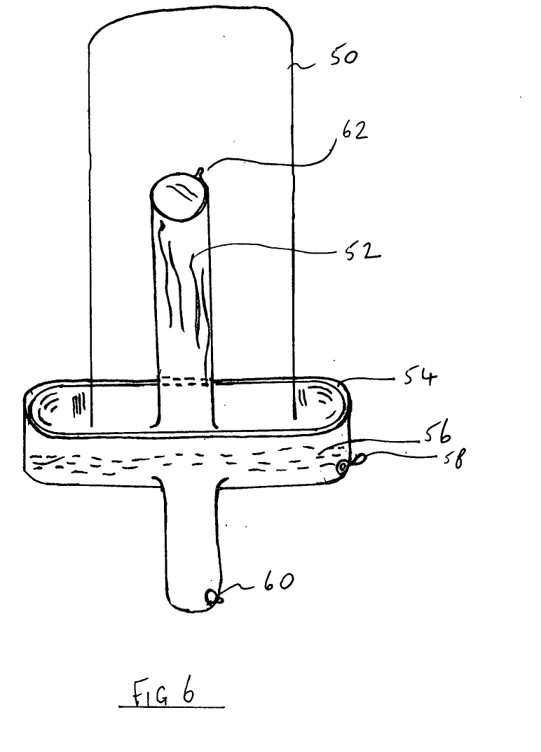

FIG. 6 shows yet another embodiment of this innovation to keep ice popsicles cooler for longer periods of time after having been removed from the freezer. In this embodiment the ice popsicle 50 is held by a stick 52 that could be hollow along its length and have a drip tray 54.

The space 56 inside the drip tray 54 could be filled with liquid, edible or inedible, or gel for the purpose of keeping the ices cooler for longer after leaving the freezer. When edible liquids are used for this purpose they can be drained away or drunk via the openings 58 or 60.

The drip tray 54 therefore serves two main purposes namely to keep the bottom of the ice popsicle from melting by holding it in a volume of ice and secondly to catch the drips from the ice popsicle when it eventually does melt. The drips from the popsicle and the melted content of the drip tray 54 can be drunk via the opening 58 or 60.

The closable opening 62 is to aid entry of liquids into the stick 52. The opening 62 could also be used to wash out the inner parts of the stick 52 when the device is used more than once.

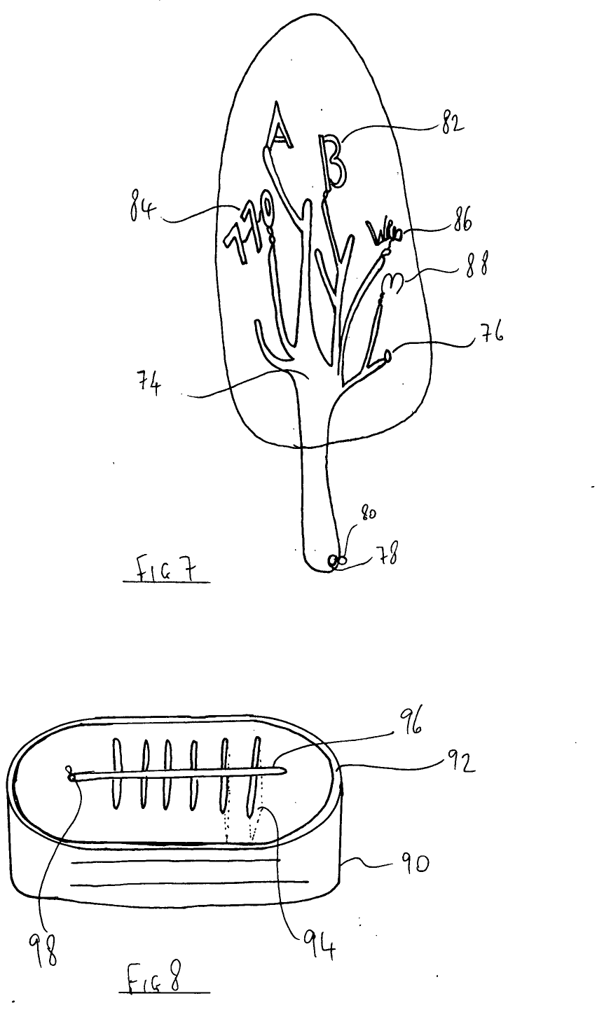

FIG. 7 is another possibility of ice cream or popsicle with a stick 74 wholly or partially hollow to allow liquids to be inserted for the purpose of keeping the ice cream or popsicle cooler for longer than if the stick were solid. There could be an opening 76 or 78 for inserting the liquid and when such liquids are edible the openings 76 or 78 could be used for drinking the melted ice. The openings 76 and 78 could be plugged with a one-time-use removable plug or have a re-useable cap 80.

The stick 74 could enjoy other features for example, for advertising, games for promotion purposes or gambling. The games could be collecting sets of letters 82 that could be made to detach with a twist. There could be words forming part of a sentence. The gambling could be related to a number 84 attached to the stick 74 or a word like “win” 86. There could be company names, logos 88 or slogans for advertising and promotion purposes.

FIG. 8 shows an ice cream container 90 with hollow outer walls 92. In the container 90 is a center piece 92 comprising hollow plastic or metal plates 94 attached to a hollow connecting tube 96. There could be openings from the connecting tube 96 and each plate 94 so that filling and emptying with liquid could be done at one capped opening 98. The effect of frozen liquid in the hollow plates 94 exposing a large cold surface area in the midst of the ice cream will keep the ice cream cooler for a longer period. As in the previous examples, if the liquid in the hollow plates 94 is edible the thawed liquid may be consumed too. Alternatively, the hollow plates 94 and connecting tube 96 could be containers with their top face open and for example frozen popsicles in plastic envelopes could be placed in the containers 94 and 96 to help cool the ice cream and at a later stage taken out and eaten or re-frozen.

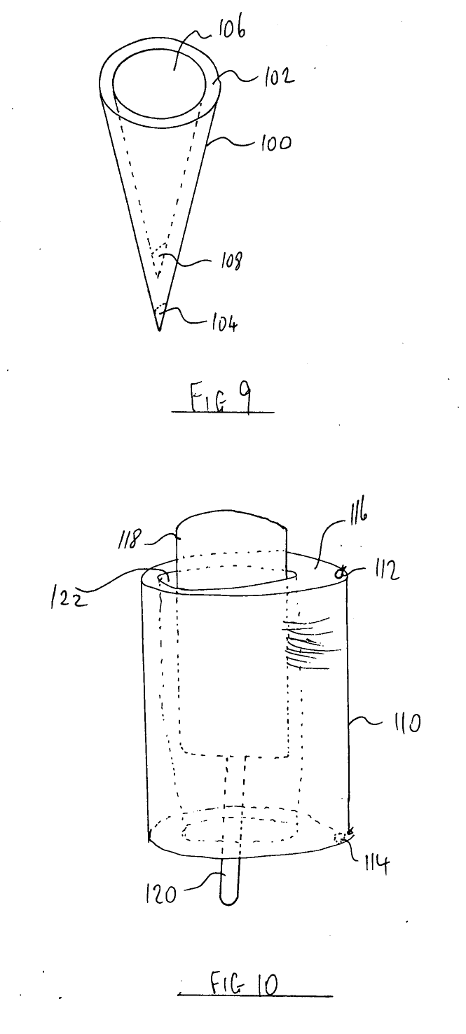

FIG. 9 shows a cone shaped ice cream holder 100 that has hollow waterproof walls 102 for filling with liquid. The entrance for filling and empting or drinking the liquid is via the cap 104.

As is the previous examples the liquid could be edible or inedible, or gel for the purpose of keeping the ice cream cooler for a longer period after leaving the freezer than would be the case if there were no such insulation. The ice cream could be placed directly in the hollow center of the cone 106 or a cone shaped wafer could be used to hold the ice cream and the wafer would fit in the hollow center 106. Alternatively, the wafer could be the outer layer and the whole unit 100 could fit inside the wafer. There could be a snapable or otherwise breakable section 108 at the apex of the internal wall of the cone 100. The liquid used in the hollow walls 102 of the cone could be an edible liquid that is like a popsicle that may be drunk as the ice popsicle melts. It could be an added enhancement as the ice cream begins to melt and the popsicle begins to melt for the consumer to snap the apex 108 and eat the remaining ice cream together with melting popsicle ice by removing the cap over the opening 104 and sucking out the mixed contents.

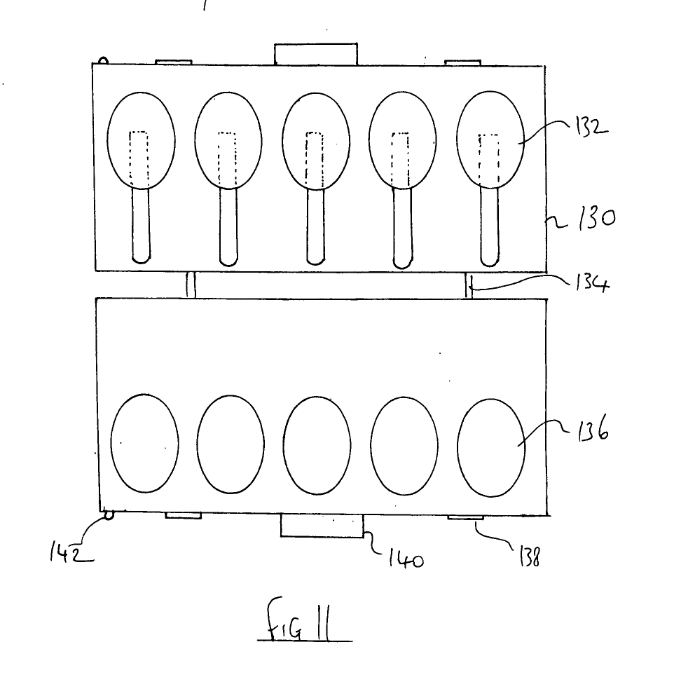

FIG. 10 is an ice cream or popsicle sleeve 110. The sleeve 110 has hollow walls 116 with a cap 112 for filling and empting 10 or drinking the contents. There could be a cap at the base 114 of the sleeve for emptying or drinking the contents. The ice cream or popsicle 118 often with a stick 120 would be placed in the hollow 122 in the central portion of the sleeve 110. The fitting of the ice cream or popsicle 118 in the sleeve hollow 122 could be tight enough to push the ice cream or popsicle 118 up gradually as it is consumed so that the lower portion of the ice cream or popsicle 118 remains surrounded by the cool sleeve 110 as long as possible thereby inhibiting the melting process.

FIG. 11 shows a cooling case 130 for ice creams and popsicles 132. The case 130 would be hollow to allow a liquid to be inserted which when frozen, would keep the ice creams or popsicles for a prolonged time after being removed from a freezer.

The case 130 could have two parts joined by hinges 134. The two parts would have indentations 136 in symmetrical formation for the ice creams or popsicles 132 to fit therein when the case 130 is closed. The case 130 could have closing clips 138 and carrying handles 140. There could be a removable cap 142 for filling and emptying the liquid used for cooling the ice creams or popsicles 132.

What is claimed:

1. A method and device for ice creams and popsicles comprising,
a. a container with hollow walls,
b. a means of filling liquid into the said hollow walls and of emptying the said liquid out of the said hollow walls,
c. indentations in the said container to accommodate and surround the said ice creams and popsicles,
whereby ice creams and popsicles can be manufactured, stored, marketed and promoted while being kept cooler for longer periods of time after having been removed from a freezer.

2. A method and device for ice creams and popsicles as claimed in claim 1 wherein the said liquids are a selection of one or more of the following namely an edible liquid, a gel, water and a liquid with a melting point higher than that of water.

3. A method and device for ice creams and popsicles as claimed in claim 1 wherein the said container is shaped like a carrying case with a top and bottom portion, a means of closing the said case and a means for carrying the said case.

4. A method and device for ice creams and popsicles as claimed in claim 1 wherein the said container is shaped like a tray.

5. A method and device for ice creams and popsicles as claimed in claim 1 wherein the said container is divided into sections each said section containing an ice cream or a popsicle.

6. A method and device for ice creams and popsicles as claimed in claim 1 wherein the said container is shaped in the shape of a cone.

7. A method and device for ice creams and popsicles as claimed in claim 6 wherein there is a means to break the inner wall of the said cone at the apex of the said inner wall.

8. A method and device for ice creams and popsicles as claimed in claim 7 wherein the said means for filling the said hollow walls of the said cone is at the apex of the outer wall of the said cone

9. A method and device for ice creams and popsicles as claimed in claim 1 wherein the said indentations are in the shape of recognizable objects for example, animals, people, fruits, conventional ice cream shapes.

10. A method and device for ice creams and popsicles as claimed in claim 1 wherein the said indentations are in a line facing opposite directions alternatively.

11. A method and device for ice creams and popsicles as claimed in claim 1 wherein the said indentations have their longitudinal axis at one end close to the center of a circle and the distal end towards the circumference of the said circle.

12. A method and device for ice creams and popsicles comprising,
a. a hollow ice cream or popsicle stick whose upper portion is used by the ice cream or popsicle to form around and hold onto, and
b. a means for filling liquid into the said hollow stick and of emptying the said liquid out of the said hollow stick,
whereby ice creams and popsicles can be manufactured, stored, marketed and promoted while being kept cooler for longer periods of time after having been removed from a freezer.

13. A method and device for ice creams and popsicles as claimed in claim 12 wherein the said liquids are a selection of one of the following namely an edible liquid, a gel, water and a liquid with a melting point higher than that of water.

14. A method and device for ice creams and popsicles as claimed in claim 12 further comprising a drip tray to catch drips of melting ice cream or melting popsicle.

15. A method and device for ice creams and popsicles as claimed in claim 14 wherein the said drip tray has hollow walls.

16. A method and device for ice creams and popsicles as claimed in claim 15 wherein there is a means for filling liquid into the said hollow walls and of emptying the said liquid out of the said hollow walls.

17. A method and device for ice creams and popsicles as claimed in claim 12 wherein the said upper portion of the said stick has attached thereto a selection of one or more of the following namely numbers, letters, words, the word “win”, advertising slogans, business logos and business trade marks.
